(19) United States
(12) Patent Application Publication
(10) Pub. No.: US 2006/0158515 A1
(43) Pub. Date: Jul. 20, 2006

(54) Adaptive motion detection interface and motion detector

(76) Inventor: Christopher Donald Sorensen, RISSKOV (DK)

Correspondence Address: CANTOR COLBURN, LLP, 55 GRIFFIN ROAD SOUTH, BLOOMFIELD, CT, 06002, US

(21) Appl. No.: 10/534,333

(22) PCT Filed: Nov. 7, 2002
(86) PCT No.: PCT/DK02/00750

§ 371 Date: Jan. 9, 2006

(51) Int. Cl. H04N 7/18

(52) U.S. Cl. 348/154

(57) ABSTRACT

The invention relates to a user interface including: motion detection means , output means adaption means adapted for the receipt of motion detection signals obtained by the motion detection means, establishing an interpretation frame on the basis of the motion detection signals and establishing and outputting communication signals to the output means on the basis of the motion detection signals and said interpretation frame. According to the invention, the user interface has been established for the use of interpreting motion provided by a user of the user interface.

### CROSS-REFERENCE TO RELATED APPLICATIONS

The present application is related to co-pending U.S. patent application Ser. No. ______ (serial number not available) in the name of Christopher Sorensen entitled, “Control System Including an Adaptive Motion Detector, which is the U.S. National State of application PCT/DK2002/000749 having an International Filing Date of Nov. 7, 2002.”

### FIELD OF THE INVENTION

The present invention relates to a user interface as defined in claim 1.

### BACKGROUND OF THE INVENTION

Several methods of communication are available within the prior art ranging from conventional interface means such as for instance keyboard, mouse and monitor of a computer to more advanced gesture reading or gesture activated systems.

Trivial examples of such systems may be the above-mentioned standard computer system comprising a standardized interface means, such as keyboard or mouse in conjunction with a monitor. Such known interface means have been modified in numerous different embodiments in which a user may, when desired, input control signals to a computer-controlled data processing.

Other very simple examples to be mentioned are automatic door opening systems, automatically controlled lighting systems, video surveillance systems, etc. Such systems have at least one significant feature in common, i.e. that the trigger criterion basically is whether something or somebody is present within a trigger zone or not. The trigger zone is typically defined by the characteristics of the applied detectors.

A further example may be voice recognition triggered systems, typically adapted for detection of certain predefined voice commands.

A common and very significant feature of all the above-mentioned systems is that the user interface is predefined, i.e. the user must adapt to the available user interface. This feature may cause practical problems to a user when trying to adapt to the user interface in order to obtain the desired establishment of control signals.

This is in particular a problem when dealing with motion-/movement-triggered systems. This problem is even more annoying when dealing with more advanced detection means due to the fact that such detection means typically require careful installation and adjustments prior to use.

It is the object of the invention to obtain a system and a method of establishing control signals having user-friendly properties and where the system and method in particular lessens the requirements to the user.

### SUMMARY OF THE INVENTION

The present invention relates to a user interface means comprising motion detection means (DM), output means (OM) and adaptation means (AM) adapted for receipt of motion detection signals (MDS) obtained by said motion detection means (MSM), establishing an interpretation frame on the basis of said motion detection signals (MDS) and establishing and outputting communication signals (CS) to said output means (OM) on the basis of said motion detection signals (MDS) and said interpretation frame.

According to the invention, the establishment of an interpretation frame may be performed more or less automatically.

According to an embodiment of the invention, the user activates a calibration mode in which the user demonstrates the interpretation frame actively by performing the intended or available motions. Upon this calibration mode the system may compare, on a runtime basis, the obtained detected motion invoked signals to the interpretation frame, and derive the associated communication signals. Such communication signals may for example be obtained as specific distinct commands or for example as running position coordinates.

According to the invention a more or less automatic interpretation frame may be established. This may for example be done by automatically applying the users initial motion invoked input as a good estimate of the interpretation frame. Moreover, this interpretation frame may in practice be adapted or optimized automatically during use by suitable analysis of the obtained motion invoked signal history.

According to the invention, the term user should be understood quite broadly as the individual user of the system, but it may of course also include a helper, for example a teacher, a therapist or even an adult.

In an embodiment of the invention, said user interface comprises signal-processing means or communicates with motion detection means (MDM) determining the obtained signal differences by comparison with the signals obtained when establishing said interpretation frame.

According to the preferred embodiment of the invention, relatively simple position determining algorithms may be applied due to the fact that the interpretation of detector signals is not locked once and for all when the system is delivered to the customer.

In an embodiment of the invention, said user interface means are distributed.

According to this embodiment of the present invention, the different parts of the system do not need to be placed at the same physical place. The motion detection means MDM naturally have to be placed where the movements to be detected are performed, but the adaptation means AM and subsequent output means OM may as well be placed anywhere else, and be connected through wireless communication means, wires, the Internet, local area networks, telephone lines, etc. Data-relaying devices may be placed between the elements of the system to enable the transmission of data.

In an embodiment of the invention, said motion detection means MDM comprise a set of motion detection sensors (SEN1, SEN2 . . . SENn).

According to this embodiment of the invention, the system comprises a number of sensors for motion detection. A preferred embodiment of the invention comprises several sensors, not to say that necessarily all of them should be used simultaneously, but rather to present the user with a choice of possible sensors.

In an embodiment of the invention, said set of motion detection sensors (SEN1, SEN2 . . . SENn) are exchangeable.

According to an embodiment of the invention, the motion detection sensors may be exchangeable. This feature enables an advantageous possibility of optimizing the performance and the characteristics of the motion detector means.

In an embodiment of the invention, said set of motion detection sensors (SEN1, SEN2 . . . SENn) forms a motion detection means (MDM) combined by at least two motion detection sensors (SEN1, SEN2 . . . SENn) and where the individual motion detection sensor may be exchanged by another motion detection sensor.

According to the above-mentioned embodiment the combined desired function of the motion detection means may be obtained by the user choosing a number of motion detection sensors suitable for the application. In other words, the user may in fact adapt the motion detection means to the application.

In an embodiment of the invention, said set of motion detection sensors (SEN1, SEN2 . . . SENn) comprises at least two different types of motion detection sensors.

The motion detection means may comprise different kinds of sensors detecting motions by means of different technologies. Such technologies may comprise detection with infrared light, laser light or ultrasound, CDC-based detection, comprising e.g. the use of digital cameras or video cameras, etc.

According to an embodiment of the invention, the user may benefit not only from a combined ability to detect certain motions obtained by geometrically distributing the detectors to cover the expected motion detection space. He may also obtain a combined measuring effect by combining different types of motion detection sensors, i.e. detection sensors having different measuring characteristics. Such different characteristics may include different ability to obtain meaningful measures in a measuring space featuring undesired high contrasts, different angle covering, etc.

It may also be appreciated that the invention facilitates the possibility of optimizing the measuring means to the intended task.

In an embodiment of the invention, said motion detection means (MDM) may be optimized by a user to the intended purpose by exchanging or adding motion detection sensors (SEN1, SEN2, . . . SENn), preferably by means of at least two different types of motion detection sensors (SEN1, SEN2 . . . SENn).

According to an embodiment of the invention, a user or a person involved in the use of the system may optimize the system, preferably in the basis of very little knowledge about the technical performance of the individual detection sensors.

In an embodiment of the invention, said at least two different types of motion detection sensors (SEN1, SEN2 . . . SENn) are mutually distinguishable.

According to this very preferred embodiment of the invention, each kind of sensor is made distinctive from the other kinds. In a preferred embodiment of the invention, the sensors are designed in such a way that they may be used without any knowledge of their internal construction or the technology they use. Thus the user may not know which of the sensors are actually cameras, or which are infrared sensors, etc. Instead, according to this embodiment, the user may know the sensors from each other by their distinctions.

The distinctions may consist in different colors, shapes, sizes, plug shapes, labels, etc. With a preferred embodiment of the invention, a user may be given instructions or advices like this: “Place green sensors in each hand of the sensor stand, and a red sensor in the head.”, “Put a cylindrical sensor on each foot of the sensor stand.”, or “If you encounter detection problems with a blue sensor, then try to replace it with a yellow.”.

The user may additionally know the sensors on their qualities rather than their technology. Thus a wide optic camera device may be referred to as a sensor for broad 10 movements or body movements, and may be assigned one color or shape, an infrared sensor may be referred to as a sensor for limb movements or movements towards and away from the sensor stand, and may be assigned a second color or shape, and a laser sensor device may be referred to as a sensor for precision measurements and be assigned a third color or shape.

By letting the user know the sensors by their qualities and conspicuous distinctions rather than their technology makes the embodiment very advantageous. The system is then very flexible and easy to upgrade or change, as the manufacturer may change the specific implementation and construction of the different sensors, as long as he just maintains their conspicuous distinctions, e.g. shape, and their specific quality, e.g. wide range. Moreover the system becomes very user-friendly, as the user does not need to know anything about how the system works or what kind of technology is most suitable for specific movements. He just needs to know what qualities are associated with what sensor shapes or colors. Also the fact that shapes and colors are recognized and distinguished by most people, even children or persons suffering from different disabling handicaps, makes this embodiment superior to an embodiment requiring the user to know what an infrared sensor is, how to distinguish a camera from an ultrasound sensor or even be able to read the words.

In an embodiment of the invention, said motion detection sensors (SEN1, SEN2 . . . SENn) physically comprise at least parts of said adaptation means (AM).

According to this very preferred embodiment of the invention, parts of the adaptation means are located within the sensors. Preferably the part of the adaptation means that receives motions detection signals MDS and on that basis establishes an interpretation frame may be physically comprised by the sensors, while it logically forms part of the adaptation means.

With such an embodiment the sensors are more or less intelligently self-controlled such that the sensors coordinate themselves according to a shared decision making algorithm. The algorithms allow the sensors to combine and send data according to the best possible predicted result for the chosen application. In a preferred embodiment the system may process and send data extrapolated within the sensor device, such that only information useful to the specific application will be sent to a further processing within the adaptation means. In this case the input devices will make decisions as to which device has the most useful information, how shall the data be filtered or smoothed, what is the best mode of transmission, which device has the best transmission connectivity to the subsequent processing means, which combination of data from the various devices should be sent and in which interval, and so forth. The decision expertise located within the sensor devices allows a much improved analysis of movement as well as an optimal utilization of the available data bandwidth for data transmission. The algorithms may include neural networks, learning systems, artificial intelligence, petri nets real time analysis and so forth.

In an embodiment of the invention, said user interface means comprise configuration means (CM) for configuring said adaptation means (AM).

This preferred embodiment of the invention makes it possible to configure different parameters of the adaptation means, e.g. parameters of the reception of motion detection signals MDS, the establishment of the interpretation frame, or how communication signals CS are established based on said motion detection signals and said interpretation frame.

Examples of parameters that may be configurable by the user are which area of the body should be monitored for movements, the position of the patient, the intended type of movement, the intended range of motion, areas of the body which should be controlled for erroneous movement, etc.

In an embodiment of the invention, said configuration means (CM) outputs information to the user through said output means (OM).

According to this very preferred embodiment of the invention, the user may get information, requests, advice, etc. from the configuration means through the output means, e.g. a computer monitor or speech synthesis.

The configuration means (CM) may e.g. give the user advice on which movements to perform with the chosen exercise, or lead the user through a configuration sequence.

In an embodiment of the invention, said configuration means (CM) represents different parameters of the adaptation means (AM) by a human figure presented to the user by means of said output means (OM).

According to this very preferred embodiment of the invention, a pedagogically representation of configuration parameters is obtained.

In an embodiment of the invention, said configuration means (CM) comprise a configuration wizard for automatically or semi-automatically leading the user through a configuration sequence.

According to this very preferred embodiment of the invention, a high degree of user-friendliness is obtained, as the user does not forget to configure any parameters, and the configuration means may continuously give the user advice and feedback on his choices.

In an embodiment of the invention, said configuration sequence comprises the steps of choosing the position of the subject, choosing the area of the body used in the exercise, indicating the desired movement for the exercise, playing back the movements of the exercise for the subject, indicating the desired output for the exercise, choosing which part of the body should be fixed or monitored for erroneous movements and choosing the strictness of error control.

According to this very preferred embodiment of the invention the user, e.g. a therapist, first chooses the position of the subject by e.g. moving a human figure on a monitor, next chooses the area of the body to be monitored by e.g. drawing a streak around the right leg, next indicates the desired movement by e.g. moving the leg back and forth by clicking and holding a pointing device while moving it, next shows to the subject, e.g. a patient, how he should move when the exercise starts, next ask the subject or chooses by himself how the feedback from the system should be, e.g. graphics on a monitor or sound, next chooses which part of the body should be fixed or monitored for error, e.g. that the subject may not move his right thigh during the exercise, and last chooses the type of error control, e.g. if the subject may not move his right thigh at all or that he may move it slightly.

In an embodiment of the invention, said user interface means comprise remote control means.

According to this embodiment of the invention, a user, e.g. a therapist, may control various parameters of the adaptation means AM or the output means OM with a remote control. This is especially advantageous when the system is distributed, as the user may then be uncomfortably far away from the adaptation means or the output means.

The remote control means may be a common infrared remote control, or it may be more advanced hand held devices such as e.g. a portable digital assistant, known as a PDA, or other remote control apparatuses. The remote control means may communicate with either the motion detection means, the adaptation means or the output means. The communication link may be established by means of infrared light, e.g. the IrDA protocol, radio waves, e.g. the Bluetooth protocol, ultrasound or other means for transferring signals.

In an embodiment of the invention, said motion detection sensors (SEN1, SEN2 . . . SENn) are driven by rechargeable batteries.

According to this very preferred embodiment of the invention, the sensors are equipped with rechargeable batteries. Thereby is obtained flexibility as the sensors do not need any wiring, and the possibility of recharging when not used makes sure that the batteries are never flat.

In an embodiment of the invention, said motion detection means (MDM) comprise a sensor tray (ST) for holding said motions detection sensors (SEN1, SEN2 . . . SENn).

According to this embodiment of the invention, a tray is provided for holding the sensors. This is beneficial when the system comprises several sensors, and only few of them are in use simultaneously. The unused ones may then be kept in the tray.

In an embodiment of the invention, said sensor tray (ST) comprises means for recharging said motion detection sensors (SEN1, SEN2 . . . SENn).

According to this very preferred embodiment of the invention, the sensors may be recharged while they are kept in the tray. Thereby is ensured that the sensors are ready to use when needed.

In an embodiment of the invention, said motion detection signals (MDS) are transmitted by means of wireless communication.

According to this very preferred embodiment of the invention, the sensors do not need to be wired to anything, as they may be driven by rechargeable means. This results in a very user-friendly and flexible system.

In an embodiment of the invention, said communication signals (CS) are transmitted by means of establishing wireless communication.

According to this very preferred embodiment of the invention, the adaptation means does not need to be wired to the output means, and thereby eases the use of the system, as well as expands the possibilities for connectivity with external devices used for output means.

In an embodiment of the invention, said wireless communication exploits the Bluetooth technology.

This embodiment of the invention comprises Bluetooth (trademark of Bluetooth SIG, Inc.) communication means implemented in the sensors and the adaptation means, or the adaptation means and the output means, or all three.

In an embodiment of the invention, said wireless communication exploits wireless network technology.

This embodiment of the invention comprises wireless network interfaces implemented in the sensors and the adaptation means, or the adaptation means and the output means, or all three. Wireless network technology comprises e.g. Wi-Fi (Wide Fidelity, trademark of Wireless Ethernet Compatibility Alliance) or other wireless network technologies.

In an embodiment of the invention, said wireless communication exploits wireless broadband technology.

This embodiment of the invention comprises wireless broadband communication means implemented in the sensors and the adaptation means, or the adaptation means and the output means, or all three.

In an embodiment of the invention, said wireless communication exploits UMTS technology.

This embodiment of the invention comprises UMTS (trademark of European Telecommunications Standards Institute, ETSI) interface means implemented in the sensors and the adaptation means, or the adaptation means and the output means, or all three.

In an embodiment of the invention, said user interface means comprise a sensor stand (SS).

According to this preferred embodiment of the invention, a sensor stand is provided for holding the sensor currently in use. By providing a sensor stand it is ensured that the sensors are placed at suitable positions and thereby an advantageous embodiment of the invention is obtained.

In an embodiment of the invention, said sensor stand (SS) has a shape recognizable as the shape of a human body.

According to this very preferred embodiment of the invention, the sensor stand has a shape that may be associated with a human body, and a very pedagogic and thereby advantageous embodiment of the invention has thereby been obtained.

In an embodiment of the invention, said output means (OM) comprise an output interface.

This very preferred embodiment of the invention enables the invention to be connected to other devices, as e.g. conventional TV-sets, computers, projectors, etc., and to interact with computer games, computer programs, TV control software, machines, etc. Thereby the present invention may be used for enabling e.g. a handicapped person to control computers, machines or other apparatuses he would not be able to fully control otherwise.

In an embodiment of the invention, said output means (OM) comprise a computer.

This very preferred embodiment of the invention lets the user interact with a computer by using the invention. The computer may comprise specialized software, e.g. rehabilitation software or data analysis software. Moreover, the computer may act as a data processing unit or a mere relaying unit to output data to other devices connected to it.

The invention further relates to a use of the above-described user interface means for rehabilitation.

According to this invention, a subject may use the user interface means described above for rehabilitation purposes. Both physical and mental diseases and disabilities may be trained and improved by use of the invention.

The invention further relates to a use of the above described user interface means for controlling electronical appliances.

According to this invention, a subject may use the user interface means described above for controlling electronical appliances, e.g. computers or TV-sets. Thus a subject may e.g. control a TV-set by sitting in an armchair and making gestures.

The invention further relates to a use of the above-described user interface means for controlling machines.

According to this invention, a subject may use the user interface means described above for controlling machines.

The invention further relates to a use of the above-described user interface means for communication.

According to this invention, a subject may use the user interface means described above for communication purposes. Thereby a subject, not able to communicate by speech, may be able to communicate by moving and making gestures. Unlike use of sign language, the invention also enables the receiving part to understand the communication without any knowledge of sign language or without even being present, as the invention may e.g. translate the gestures to spoken or written words.

The invention further relates to a motion detector comprising a set of partial detectors of different types with respect to detection characteristics.

According to an embodiment of the invention, a combined detector functionality may be established as a combination of different detectors and where at least two of the detectors feature different detection characteristics. In this way, a detector may be optimized for different purposes if so desired. This may for instance be done by the incorporation of the output of certain types of detectors when certain types of motions are performed in certain environments.

In other applications partial detectors may be applied depending on the obtained output.

According to a preferred embodiment of the invention, such calibration and selection of the best performing transducers may simply be performed by the user demonstrating the motions to be detected and then subsequently determining what transducers feature the best differential output.

Evidently, the combined motion detector output may be pre-processed prior to handing over of the motion detector output to the application controlled by the motion detector.

In an embodiment of the invention, the motion detector is adaptive.

The invention further relates to a motion detector for use in an interface as described above.

### LIST OF DRAWINGS

The invention is in the following described with reference to the drawings, of which

FIG. 1 shows an overview of the present invention,

FIG. 2 shows the motion detection means in more detail,

FIG. 3 shows a human shaped sensor stand,

FIG. 4 shows a full embodiment of the invention, and

FIG. 5a-5c illustrate further advantageous embodiments of the invention.

### DETAILED DESCRIPTION

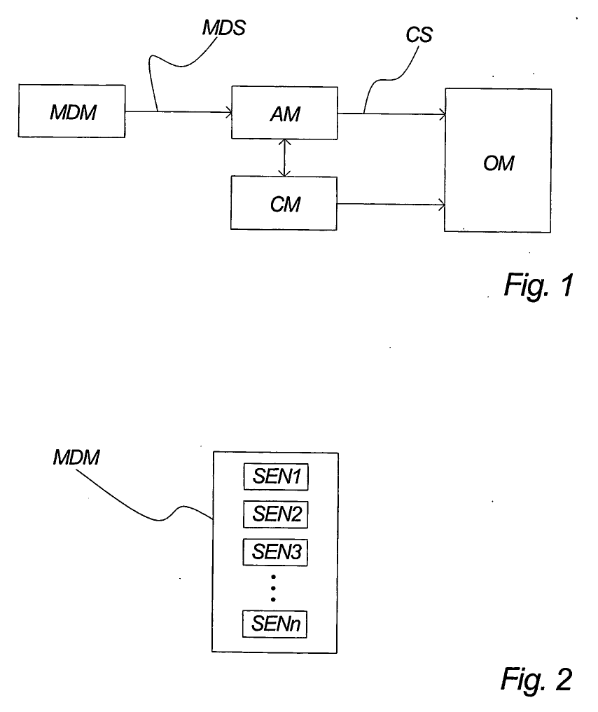

FIG. 1 shows a preferred embodiment of the present invention. It comprises motion detection means MDM, adaptation means AM, configuration means CM and output means OM. The motion detection means MDM send motion detection signals MDS to the adaptation means AM, and the adaptation means send communication signals CS to the output means OM.

The motion detection means MDM comprise a set of motion detection sensors SEN1, SEN2, . . . , SENn, as shown in FIG. 2.

The adaptation means AM have several functions. They receive the motion detection signals MDS from the sensors, interpret them, and send communication signals CS to the output media. How the motion detection signals MDS should be interpreted is defined by an interpretation frame also established by the adaptation means. The interpretation frame is established on the basis of the types of sensors present, the movements the user makes, and the exercise or end use of the interface.

To let the user configure the adaptation means regarding the establishment of a suitable interpretation frame and more, configuration means CM may be provided. They communicate with the adaptation means AM and send information, advices or requests to the user by means of the output means OM. The configuration means CM may be passive, only providing the user with input means for changing various parameters, or it may be active or intelligent, leading the user through the configuration, and/or giving him advices and help. The configuration means CM may comprise a configuration wizard, which only presents the user with one configuration parameter at a time and lets the user choose when to proceed to the next parameter. Thereby the configuration of the system becomes very easy to do.

The adaptation means AM may be physically located in one box or they may be distributed in various physical locations in the system. A very preferred embodiment of the invention lets the sensors comprise parts of the adaptation means AM, such that they together may control the data forwarded to the subsequent part of the adaptation means. Thus a data filtering and enhancement is performed at the earliest possible stage, saving processing power and communication means.

As mentioned above, the motion detection means MDM comprise a set of sensors SEN1, SEN2, . . . , SENn. A preferred embodiment of the invention comprises several more sensors than used for one purpose, as different exercises or purposes may require a different amount of sensors. Moreover, the embodiment preferably comprises different kinds of sensors, e.g. infrared, CCD, etc., and preferably several sensors of each type. Thus, it is possible to exchange the sensors in use with spare sensors, e.g. of a different kind. This is a very advantageous aspect of the invention, as it greatly increases the flexibility of the system. Moreover it is possible to adapt the system to any user requirements, exercises or movements, etc.

The output means OM may itself comprise projectors, monitors, speech synthesizers, etc. but it may as well comprise an output interface to other systems thus making it possible to use the present invention as user interface for almost any conventional computer program, electronical appliance, machine, etc. In a preferred embodiment the output means comprise a computer which output is shown on a screen by means of a projector. The computer preferably comprises specialized rehabilitation software, e.g. a simple game, which requires the user to e.g. move a damaged limb in a rehabilitating way to succeed in the game.

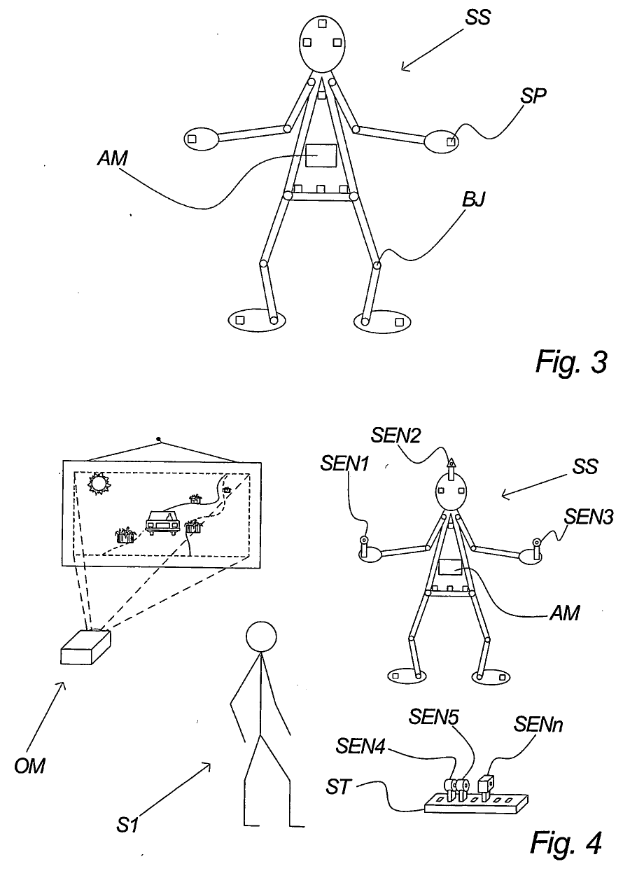

FIG. 3 shows a preferred embodiment of a sensor stand SS. Its shape is intended to be associated with the outline of a human body. The sensor stand SS comprises a number of bendable joints BJ, placed such that the legs and the arms of the stand may be bend in much the same way as the equivalent legs and arms of a human body. The sensor stand SS further comprises a number of sensor plugs SP, placed at different positions on the stand in such a way that a symmetry between the left and the right side of the stand is obtained. Furthermore, the sensor stand SS comprises adaptation means AM.

The shape of a human body is preferred, as it is more pedagogic than e.g. microphone stands or other stands or tripod usable for holding sensors. When the system is used with e.g. handicapped persons or children, pedagogically formed devices are very preferred. It is however noted that any shape or type of stand suitable for holding one or more sensors is applicable to the system.

The sensor plugs SP make it possible to place sensors on the stand and may beside real plugs be clamps or sticking materials such as e.g. Velcro (trademark of Velcro Industries B.V.) or any other applicable mounting gadget. The positions of the sensor plugs are selected on the basis of knowledge of possible exercises and users of the system. Preferably, there are several more sensor plugs than usually used with one exercise or one user to increase the flexibility of the sensor stand. When e.g. the sensor stand is used for rehabilitation at a clinic where different patients make different exercises under guidance of different therapists a flexible sensor stand with several possible sensor locations is preferred. On the other hand, less possible sensor positions make the stand simpler to use and it may besides be cheaper to manufacture. Such an alternative may be preferred by a single user having the stand in his home to regularly perform a single exercise.

FIG. 4 shows a full, preferred embodiment of the invention. It comprises a first subject S1, subject to rehabilitation, a sensor stand SS, a sensor tray ST and output media OM. Furthermore, several sensors SEN1, SEN2, SEN3, SEN4, SEN5 and SENn are comprised. Three of them are put on the sensor stand and the rest are placed in the sensor tray ST. The sensor stand SS furthermore holds adaptation means AM. The output media OM are a projector showing a simple computer game on a screen.

The sensors SEN1, SEN2, . . . , SENn have different shapes, cylindrical, triangular and quadratic, to enable a user to distinguish them from each other. For the embodiment shown in FIG. 4, the cylindrical sensors SEN1, SEN3, SEN4 and SEN5 may be of an infrared type, while the triangular sensor SEN2 may be a digital video camera, and the quadratic sensor SENn may be of an ultrasound type.

The different shapes enable the user to distinguish between the sensors, even without any knowledge of their comprised technologies or their qualities. A more trained user, e.g. a therapist, may further know the sensors by their specific qualities, e.g. wide range or precision measurements, and may associate the sensor's qualities with their shapes. This is a very advantageous embodiment of the sensors, as it greatly improves user-friendliness and flexibility and it moreover enables the manufacturer to apply a common design to all sensors, regardless of them being cameras of laser sensors, as long as just one visible distinctive feature is provided for each sensor type. The simple distinction of sensors in opposition to a more technical distinction also enables the configuration means, user manual or other to easily refer the specific sensor types with a language everybody understands.

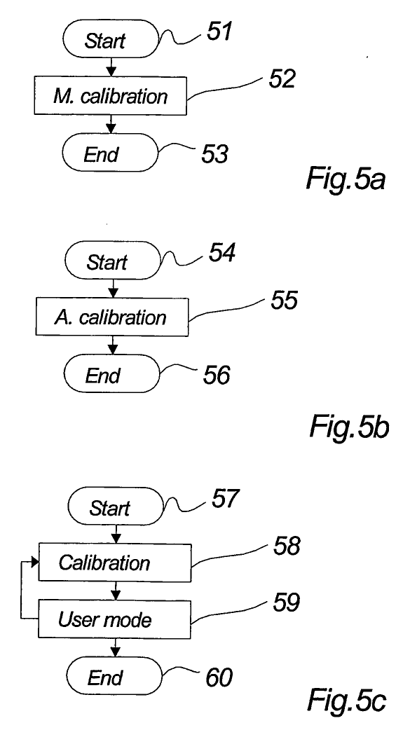

FIG. 5a to 5c illustrate further advantageous embodiments of the invention. Basically, the figures illustrate different ways of calibrating detectors, preferably motion detectors such as IR-detectors, CCD detectors, radar detectors, etc. Evidently, according to a preferred embodiment of the invention, the applied detectors are near field optimized.

The illustrated calibration routines may in principle be applied, but not restricted to, the embodiment illustrated in FIG. 1 to 4.

FIG. 5a illustrates a manual calibration initiated in step 51. When entering step 52, a manual calibration is initiated. A manual calibration may simply be entered by the user manually activating a calibration mode, typically prior to the intended use of a certain application. It should, however, be noted that a calibration may of course be re-used if the user desires to use the same detector setup with the same application or re-use the calibration as the starting point of a new calibration.

The manual calibration may for example be performed as a kind of demonstration of the movement(s) the system and the setup is expected to be able to interpret. Such demonstration may for example be supported by graphical or e.g. audio guidance, illustrating the detector system outputs resulting from the performed movements. The calibration may then be finalized by applying a certain interpretation frame associated to the performed movements.

The interpretation frame may for example be an interval of X, Y (and e.g. X) coordinates associated to the performed movement and/or for instance an interpretation of the performed movements (e.g. gestures) into command(s).

The manual calibration should preferably, when dealing with high resolution systems be supported by a sought calibration wizard actively guiding the user through the calibration process, e.g. by informing the user of the next step in the calibration process and on a run-time basis throughout the calibration informing the user of the state of the calibration process. This guidance may also include the step of asking the calibrating user to re-do for instance a calibration gesture to ensure that the system may in fact make a distinction between this gesture and another calibrated gesture associated to another command.

In step 53 the calibration is finalized.

FIG. 5b illustrates a further embodiment of the invention

FIG. 5b illustrates an automatic calibration initiated in step 54. When entering step 55, an automatic calibration is initiated. An automatic calibration may simply require a certain input by the user, typically the gesture of a user, and then automatically establish an interpretation frame

In step 56 the calibration is finalized.

FIG. 5c illustrates a hybrid adaptive calibration. In other words, the application may, subsequently to a manual or automatic calibration procedure in step 58 enter the running mode of an application in step 59. The calibration may then subsequently be adapted to the running application without termination of the running application (when seen from the user)

Such hybrid adaptive calibration may e.g. be performed as a repeated calibration performed in certain intervals or activated by certain user acts and calibrated to for example the last five minutes of user inputs.

Several other calibration routines or calibration acts may be performed within the scope of the invention.

1. User interface comprising
motion detection means;
output means; and
adaptation means adapted for receipt of motion detection signals obtained by said motion detection means establishing an interpretation frame on the basis of said motion detection signals and establishing and outputting communication signals to said output means on the basis of said motion detection signals and said interpretation frame.

2. User interface according to claim 1, wherein said user interface further comprises signal processing means or communicates with motion detection means determining obtained signal differences by comparison with the signals obtained when establishing said interpretation frame.

3. User interface according to claim 1, wherein said user interface is distributed.

4. User interface means according to claims 1, wherein said motion detection means comprises a set of motion detection sensors .

5. User interface according to claim 4, wherein said set of motion detection sensors is exchangeable.

6. User interface means according to claim 4, wherein said set of motion detection sensors forms a motion detection means combining at least two motion detection sensors wherein an individual motion detection sensor may be exchanged by another motion detection sensor.

7. User interface according to claims 4, wherein said set of motion detection sensors comprises at least two different types of motion detection sensors.

8. User interface according to claim 1, wherein said motion detection means may be optimized by a user to an intended purpose by exchanging or adding of motion detection sensors said motion detector sensors including at least two different types of motion detection sensors.

9. User interface according to claim 7, wherein said at least two different types of motion detection sensors are mutually distinguishable.

10. User interface means according to claim 4, wherein said motion detection sensors comprise at least parts of said adaptation means.

11. User interface according to claim 1, wherein said user interface further comprises configuration means for configuring said adaptation means.

12. User interface according to claim 4, wherein said configuration means outputs information to a user through said output means.

13. User interface according to claim 11, wherein said configuration means represents different parameters of the adaptation means by a human figure presented to a user by said output means.

14. User interface according to claim 11, wherein said configuration means comprises a configuration wizard automatically or semi-automatically leading a user through a configuration sequence.

15. User interface according to claim 14, wherein said configuration sequence comprises:
choosing a position of a subject;
choosing an area of a body used in the exercise;
indicating desired movement for the exercise;
playing back the movements of the exercise for the subject;
indicating desired output for the exercise;
choosing which part of the body should be fixed or monitored for erroneous movements and
choosing a strictness of error control.

16. User interface according to claim 1, wherein said user interface further comprises remote control means.

17. User interface according to claim 4, wherein said motion detection sensors are driven by rechargeable batteries.

18. User interface according to claim 4, wherein said motion detection means comprises a sensor tray for holding said motion detection sensors.

19. User interface according to claim 4, wherein said sensor tray comprises means for recharging said motion detection sensors .

20. User interface according to claim 1, wherein said motion detection signals and/or said communication signals are transmitted by wireless communication.

21. (canceled)

22. User interface according to claim 20, wherein said wireless communication exploits Bluetooth technology.

23. User interface according to claim 20, wherein said wireless communication exploits wireless network technology.

24. User interface according to claim 20, wherein said wireless communication exploits wireless broadband technology.

25. User interface according to the claim 20, wherein said wireless communication exploits UMTS technology.

26. User interface according to claim 1, wherein said user interface further comprises a sensor stand.

27. User interface according to claim 26, wherein said sensor stand has a shape recognizable as the shape of a human body.

28. User interface according to claim 1, wherein said output means comprises an output interface.

29. User interface according to claim 1, wherein said output means comprises a computer.

30. Use of user interface according to claim 1 for rehabilitation.

31. Use of user interface according to claim 1 for controlling electronical appliances.

32. Use of user interface according to claim 1 for controlling machines.

33. Use of user interface according to claim 1 for communication.

34. Motion detector comprising a set of partial detectors of different types with respect to detection characteristics.

35. Motion detector according to claim 34, wherein the motion detector is adaptive.

36. Motion detector for use in an interface according to claim 1.
